(19) United States
(12) Patent Application Publication
(10) Pub. No.: US 2003/0086165 A1
(43) Pub. Date: May 8, 2003

(54) Illuminated reticle

(76) Inventors: John W. Cross, Overland Park, KS (US); Christopher A. Lalik, Overland Park, KS (US)

Correspondence Address: HOVEY WILLIAMS TIMMONS & COLLINS, 2405 GRAND BLVD., SUITE 400, KANSAS CITY, MO, 64108

(21) Appl. No.: 10/011,629

(22) Filed: Nov. 5, 2001

(51) Int. Cl. G02B 23/00

(52) U.S. Cl. 359/424; 359/399; 359/428

(57) ABSTRACT

Reticles and scopes using reticles are provided with increased visibility in low-light conditions by illuminating the reticle using the light emitted by a quantity of photoluminescent material. The photoluminescent material may be placed on the reticle itself or emit light which is cast onto the reticle. In some forms, the reticle is entirely coated with the photoluminescent material and in other forms, the photoluminescent material is selectively deposited on a portion of the reticle or an area adjacent the reticle. In other forms, the photoluminescent material is located remote from the reticle and the light emitted from the reticle is transmitted to the reticle. Alternatively, the light may be transmitted directly into a disc of optical material which has an area etched into a reticle pattern whereby the transmitted light escapes from the disc through the etched out portion and provides an illuminated reticle pattern which is visible in low light conditions.

### BACKGROUND OF THE INVENTION

1. Field of the Invention

The present invention is concerned with the use of scopes in low-light conditions. More particularly, scopes in accordance with the present invention utilize a reticle to aid in range-finding and aiming of the scope or an object attached to the scope. Still more particularly, the present invention concerns illuminating the reticle such that the scope maybe utilized in low-light conditions without sacrificing the utility of the reticle. Even more particularly, the present invention involves the use of photoluminescent material to aid in the illumination of the reticle. The photoluminescent material may be deposited directly on the reticle or in an area adjacent the reticle such that ambient light from the photoluminescent material illuminates the reticle. When deposited directly on the reticle, the photoluminescent material may be found on only a portion of the reticle as an enhanced sighting marker such as the center of a cross-hair or may be used on the entire reticle.

2. Description of the Prior Art

Scopes utilizing reticles as sighting markers have been in use for many years. Because the reticle is located within the housing of the scope, the usefulness of prior art reticles is decreased in low-light conditions. This loss of utility is a result of the lack of light illuminating the reticle and making it visible to the person looking through the scope. Such a deficiency makes the aiming of scopes more difficult in low-light conditions as the reticle as a sighting marker cannot be differentiated from the object being observed through the scope. In the case of hunters using riflescopes having reticles, this problem makes hunting in low-light conditions difficult due to the lack of precision resulting from a reticle which is undifferentiated from the hunted animal and surrounding background.

There have been many attempts to overcome this problem but all solutions of the prior art suffer various deficiencies. For example, U.S. Pat. No. 4,627,171, to Dudney provides a cross-hair illuminator which uses a lamp powered by a battery which transmits light through a fiber optic cable onto the reticle. Such a solution requires the use of batteries which suffer from dramatically reduced output and life in low temperature conditions. Furthermore, the battery may become exhausted prior to the end of the a hunt, thereby requiring either replacement of the battery during which time potential sighted objects may move out of range, or loss of the advantage provided by an illuminated reticle. Another example is provided by U.S. Pat. No. 5,456,035 to Stiles which illuminates the reticle using a chemically illuminated reticle sight. Light from a chemical illumination device is used to create a reticle image which is highly visible in low-light conditions. Such an invention suffers from the short life of the light produced by the chemicals. As a result, replacement chemicals must be available for use in case the light fades or disappears. Another solution to this problem has been the incorporation of radioactive materials to illuminate the reticle. Such a solution obviously requires special handling techniques and presents difficult manufacturing problems. Other solutions to this problem include using illumination sources which either illuminate the sighted object or illuminate an area around the scope. Each of these solutions is undesirable in that either the sighted object becomes aware of the illuminated area or the hunter's position is given away by the light, thereby reducing the possibility of approaching the sighted object without being detected.

Accordingly, what is needed is an illuminated reticle which does not require electrical current or light sources which need to be replaced. What is further needed is an illuminated reticle which does not illuminate the sighted object or an area around the scope.

### SUMMARY OF THE INVENTION

The present invention overcomes the problems outlined above and provides a unique advance in the state of the art. Briefly, the present invention utilizes photoluminescent material to illuminate a reticle such that the scope containing the reticle can be used in low-light conditions. Using photoluminescent material is advantageous over other methods of illuminating reticles in that photoluminescent material does not need to be replaced in order to become recharged, does not require electrical current, does not illuminate the sighted object, and does not illuminate an area around the scope. By having an illuminated reticle, animals or objects which are active in the early morning or the late evening are more visible and the user of such a scope will be able to focus their vision more quickly and accurately than was heretofore possible.

In one aspect of the present invention, a quantity of photoluminescent material is deposited on the reticle. The photoluminescent material may be deposited on only a portion of the reticle or it may substantially cover the reticle. The photoluminescent material may be in granular form, in a paint or dye, incorporated in tape, or any combination of these forms. It is preferred that the particle size of the photoluminescent material be less than about 30 μm. Such a small particle size permits the photoluminescent material to have sharply defined edges when incorporated into a paint or dye. More preferably, the particle size is between about 2 μm and 20 μm. Still more preferably, the average particle size is between about 5 μm and 10 μm.

When the photoluminescent material is deposited on the reticle, the light emitted from the material illuminates the reticle so that it can be seen and used in low-light situations. Depositing the photoluminescent material can be accomplished using many different conventional methods including dipping, airbrushing, standard paint brushing, powder coating, vacuum deposition, sputtering, gluing, various photolithographic processes, and combinations of all of these methods. The material deposited on the reticle may be in any shape or may be directly incorporated into reticle or even used as the reticle itself. When not used as the reticle, the photoluminescent material may be deposited on any portion of the reticle or in an area adjacent the reticle which does not interfere with the view through the scope but which still allows light emitted from the material to illuminate the reticle. For example, the photoluminescent material may be placed in sufficient quantity around the edge of the reticle and the light emitted illuminates the reticle. Alternatively, the photoluminescent material may be used as an enhanced sighting marker by being deposited on a portion of the reticle. For example, in a conventional cross-hair sighting marker, any portion of the cross-hairs may comprise photoluminescent material which will illuminate the reticle. For example, the reticle may comprise a conventional cross-hair pattern and the center of the cross hair may comprise or have photoluminescent material deposited thereon, thereby providing an enhanced sighting marker on the reticle. Thus, the reticle may comprise a first line intersected by a second line and oriented such that the first line is perpendicular to the second line and any portion of these lines may include photoluminescent material. Such is also true for the circumscribing ring which is commonly used to encircle the crosshair region of a reticle. Alternatively, the photoluminescent portion may comprise a dot of photoluminescent material on the reticle.

In some forms, the photoluminescent material will be included as the reticle itself. For example, fine strips of photoluminescent material may be used to construct the reticle. Alternatively, when the reticle is located on another object such as a plate of optical material, the photoluminescent material may be deposited onto the reticle or comprise the reticle, as described above.

In another aspect of the invention, a riflescope having enhanced utility in low light conditions is provided. Generally, the riflescope will comprise a tubular housing having an interior and an exterior and two opposed ends. One end of the housing will have an eyepiece and the other end will have an objective lens. A reticle will be located in the interior of the housing between the two opposed ends and photoluminescent material will be deposited on the interior of the housing in order to illuminate the reticle. Preferably, the photoluminescent material is located adjacent to the reticle in order to aid in its illumination. In some forms, the photoluminescent material is placed on the interior of the housing in a ring shape in order to provide the reticle with even levels of light about the entire reticle. Such a ring shape may circumscribe the interior of the housing as an uninterrupted coat of photoluminescent material or may be in the form of a broken series of lines of photoluminescent material to provide a ring comprised of dash shapes.

In another aspect of the present invention, the photoluminescent material is located away from the interior of the housing of a scope, remote from the reticle, and the light emitted from the photoluminescent material is transmitted to the reticle via a light-transmitting pipe. One preferred example of a light-transmitting pipe is fiber optic cable. In this form of the invention, a scope will include a quantity of photoluminescent material on the housing of the scope and the pipe will transmit the light from the material to the interior of the scope housing wherein the light will be cast onto the reticle. Another form of this embodiment will have the light-transmitting pipe terminate adjacent the edge of a plate of optical material. Preferably, there will be two pipes leading from the photoluminescent material to the plate of optical material and these two pipes will have their light-transmitting end terminate at the edge of the plate and be oriented at 90° angles relative to each other. The plate of optical material will have an etched portion which allows light emitted from the pipe and into the plate to escape from the etched out portion of the plate and escape. The escaping light serves as an illuminated reticle and provides a reticle identical in shape to the etched out portion. Preferably, the plate of optical material will also include an anti-reflective layer and a protective layer thereon which will both be etched out during the etching process. In another embodiment using a light transmitting pipe optically connected to a quantity of photoluminescent material, the pipe is secured to the reticle and the end of the pipe which emits light is positioned on the reticle and aimed so that it serves as the illuminated reticle. That is to say, the end of the pipe emitting light is aimed toward the eyepiece end of the scope such that a user of the scope can see the emitted light and it serves as the reticle.

When the photoluminescent material is located remote from the reticle, it may be contained in a receptacle located on the housing of a scope. Preferably, the receptacle will have a removable cap and in some preferred embodiments, the cap will have the photoluminescent material therein. In other forms of the invention, the photoluminescent material will be removably placed in the receptacle. Regardless of the particular structure, the photoluminescent material will be transmitted from a location remote from the reticle to a location either adjacent to or on the reticle.

Scopes useful with the present invention are any scopes which utilize a reticle. Such scopes include riflescopes, telescopes, spotting scopes, binoculars, and the like. When the form of the invention using light transmitted via a light-transmitting pipe optically connected with photoluminescent is used in conjunction with rifles, the photoluminescent material may be located on the housing of the scope or may be on the rifle to which the scope is connected.

In use, the photoluminescent material of the present invention is activated by exposing the material to a light source. This exposure can be either direct exposure or indirect exposure. Once the material is activated, it will emit a quantity of light for a period of time related to the amount of activation or charging. It is this emitted light which is used to illuminate reticles in scopes, thereby increasing their utility in low-light conditions.

### BRIEF DESCRIPTION OF THE DRAWINGS

FIG. 1 is an illustration of a riflescope in accordance with the present invention;

FIG. 2 is an illustration of a circle-x reticle having a quantity of photoluminescent material thereon;

FIG. 3 is an illustration of a mil-dot reticle having a quantity of photoluminescent material thereon;

FIG. 4 is an illustration of a multiplex reticle having a quantity of photoluminescent material thereon;

FIG. 5 is an illustration of a low light reticle having a quantity of photoluminescent material thereon;

FIG. 6 is an illustration of a low light reticle having a center dot with a quantity of photoluminescent material thereon;

FIG. 7 is an illustration of a reticle inside the housing of a scope that is illuminated by a band of photoluminescent material adjacent the reticle;

FIG. 8 is an illustration of a reticle inside the housing of a scope that is illuminated by a broken band of photoluminescent material adjacent the reticle;

FIG. 9 is a perspective view of a reticle in a reticle housing having a layer of photoluminescent material thereon;

FIG. 10 is a perspective view of a disc of optical material having an etched out reticle pattern in the center thereof and two light sources on the periphery thereof;

FIG. 11 is a cross-sectional view through the center of FIG. 12 illustrating the etched out portion;

FIG. 12 is a cross sectional view of the eyepiece end of a scope illustrating a quantity of photoluminescent material located remote from the reticle; and

FIG. 13 is a view of a reticle having an illuminated center dot wherein the dot is illuminated by being at the end of a light transmitting pipe.

### DETAILED DESCRIPTION OF THE PREFERRED EMBODIMENTS

The following description sets forth preferred embodiments of the present invention. It is to be understood, however, that these embodiments are provided by way of illustration and nothing therein should be taken as a limitation upon the overall scope of the invention.

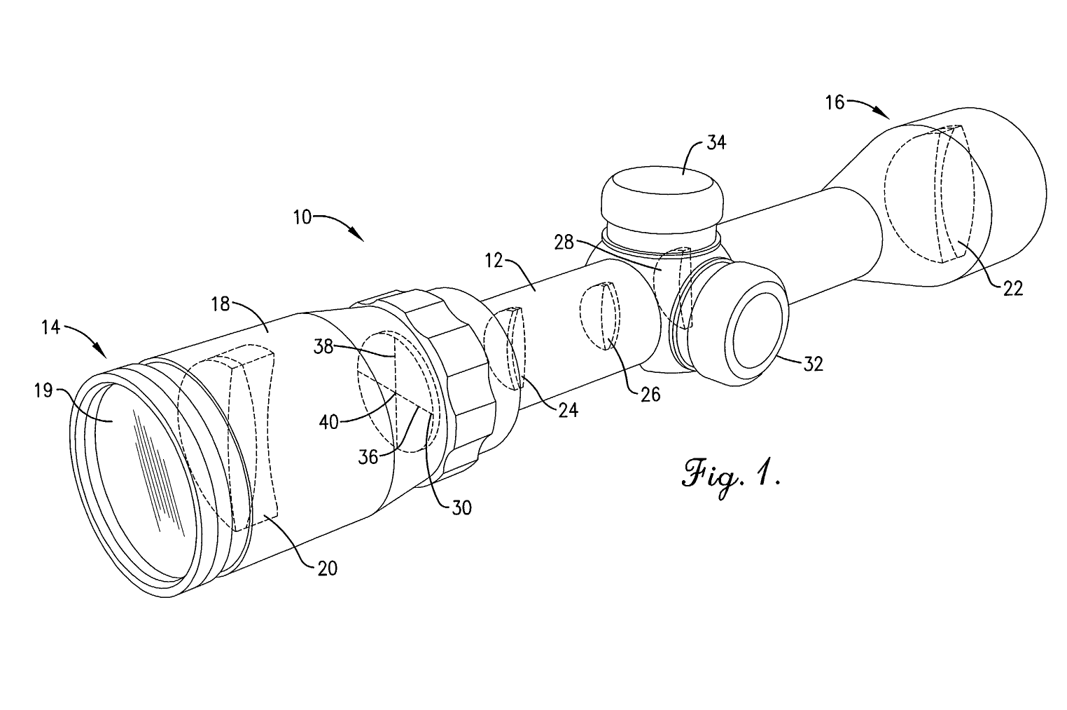

Turning now to the drawing figures, FIG. 1 illustrates a riflescope 10 in accordance with the present invention. The scope 10 presents an elongated tubular housing 12 having a first end 14 and an opposed second end 16. First end 14 terminates at eyepiece 18 which includes a first eyepiece lens 19 and a second eyepiece lens 20. Second end 16 terminates at objective lens 22 which is also located within housing 12. There are also three erector lenses 24, 26, 28 located within housing 12 between first end 14 and second end 16. Reticle 30 is located within housing 12 between first end 14 and erector lens 24. This places reticle 30 in the second focal plane of the riflescope 10. However, reticle 30 may also be located in the first focal plane (between lens 26 and 22) either alone or together with another reticle in the second focal plane. Located on housing 12 are covers for the windage adjusting screw 32 and the elevation adjusting screw 34.

In accordance with the present invention, reticle 30 will comprise a quantity of photoluminescent material on cross-hairs 36, 38, thereby providing an illuminated reticle which will provide greater utility under low light conditions. This photoluminescent material may be located at any position on either cross-hair 36, 38. Alternatively, either one or both cross-hairs may have photoluminescent material deposited thereon or the intersection 40 of the cross-hairs 36, 38 may be the only point at which there is photoluminescent material.

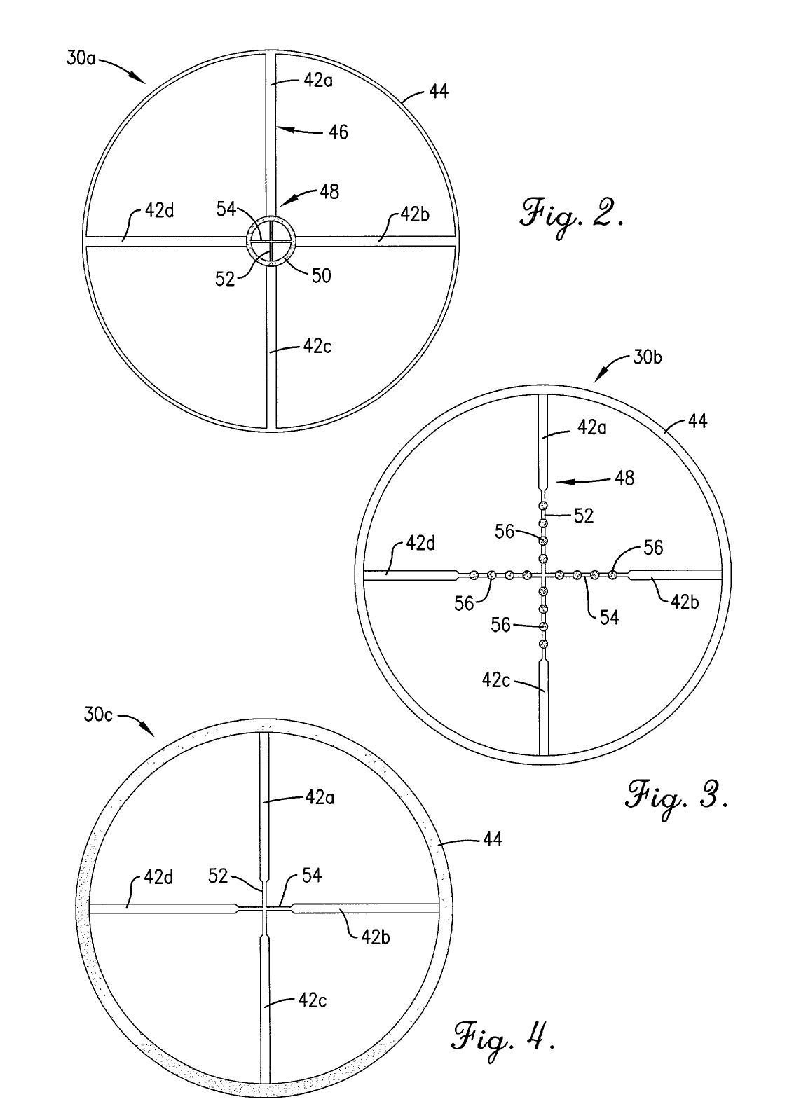

FIGS. 2-6 illustrate some of the potential reticle embodiments that are possible with the present invention. As shown by the wide variety of applications possible in accordance with the present invention, one of ordinary skill in the art will understand that the construction of the reticle, the orientation of the sighting markers of a reticle, and the placement of photoluminescent material on or around a reticle is a matter of choice.

FIG. 2 illustrates a conventional circle-x reticle 30a. Reticle 30a presents four wide band cross-hairs 42a, 42b, 42c, 42d encircled by a circumscribing ring 44. Crosshairs 42a, 42b, 42c, 42d each present a first end 46 adjacent ring 44 and a second end 48 which terminates at interior ring 50 which circumscribes two thin band cross hairs 52, 54 which are oriented perpendicularly to each other. In this embodiment, ring 50 and cross-hairs 52, 54 have a quantity of photoluminescent material deposited thereon which illuminates the center of the reticle, thereby providing an enhanced sighting marker at the center of the reticle which is useful in low-light conditions. The photoluminescent material could be deposited on ring 50 and cross-hairs 52, 54 using any conventional process including painting, dipping, airbrushing, standard brushing, powder coating, vacuum deposition, sputtering, gluing, or even be used as the reticle itself. Of course, the reticle can be formed of any material which could be used as a reticle such as thin pieces of metal wire, spider webs, or even thin film alloys such as a nickel alloy. Some of these materials use a photolithographic process to etch a reticle pattern out of the material and this etched out pattern may be applied to a plate of optical material and subsequently covered with a protective coating and/or an antireflective (AR) coating. In another alternative embodiment, a thin sheet of photoluminescent material is shaped into a reticle pattern by cutting or etching and the entire reticle would then comprise photoluminescent material.

FIG. 3 illustrates another reticle 30b, commonly known as a mil-dot reticle which includes wide-band cross-hairs 42a, 42b, 42c, 42d which extend from reticle ring 44 to cross-hairs 52, 54. These wide-band cross-hairs have a tapered second end 48 eventually leading to cross-hairs 52, 54 which have a plurality of dots 56 comprising photoluminescent material. These dots 56 aid in directing a user's eye to the center of the reticle 30b and the photoluminescent material increases visibility of reticle 30b in low-light conditions. Dots 56 may be applied or deposited to cross-hairs 52, 54 as described above.

FIG. 4 illustrates a multiplex reticle 30c in accordance with the present invention. Reticle 30c includes circumscribing ring 44, wide-band cross-hairs 42a, 42b, 42c, 42d which taper into thin cross-hairs 52, 54. In this embodiment, ring 44 includes the photoluminescent material which emits enough light to illuminate the reticle. Typically, reticles similar to reticle 30c are made via conventional photolithographic processes on thin film nickel alloy. Again, the photoluminescent material may be applied or deposited to ring 44 as described above.

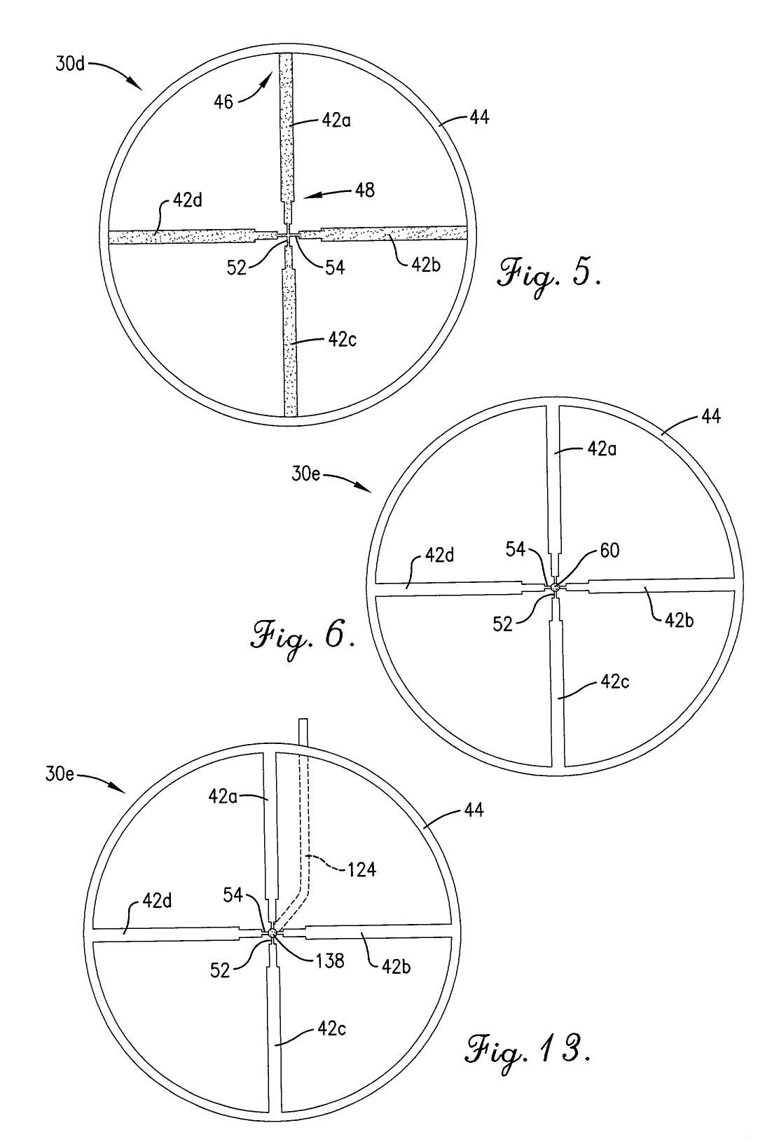

FIG. 5 illustrates one version of a low-light reticle 30d. This reticle includes ring 44, wide-band cross-hairs 42a, 42b, 42c, 42d, and thin cross-hairs 52, 54. The first end 46 of the wide-band cross-hairs terminates in ring 44 while second end 48 includes narrow portion 58 at the end thereof. Thin cross-hairs 52, 54 extend from portion 58, intersecting at the center of reticle 30d. Photoluminescent material is applied to, deposited on, or comprises wide-band cross-hairs 42a, 42b, 42c, 42d and thin crosshairs 52, 54 such that both of these sighting markers emits light after being charged with either ambient light or directed light.

FIG. 6 is similar to FIG. 5, however, there is a quantity of photoluminescent material at the intersection of thin cross-hairs 52, 54 in the form of a center dot 60. Because the center dot 60 comprises photoluminescent material, the visibility at this center of aim is increased in low-light conditions.

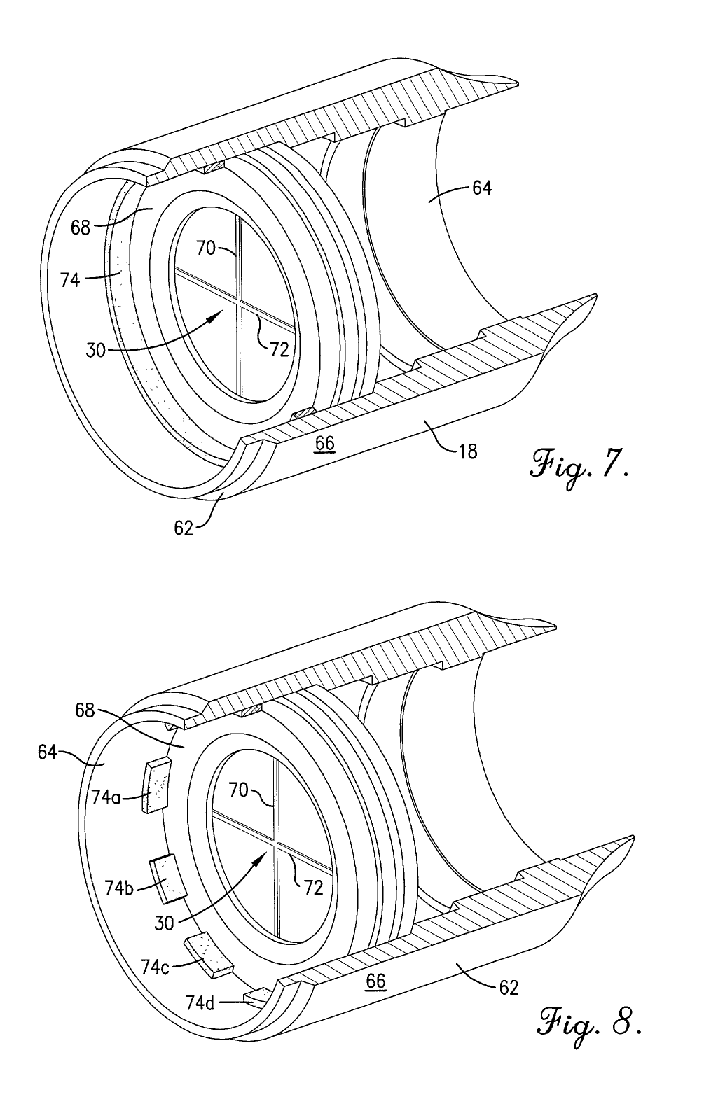

FIG. 7 illustrates another embodiment in accordance with the present invention wherein a cut-away version of eyepiece 18 is shown without eyepiece lenses 18, 19. Eyepiece 18 includes housing 62 having an interior surface 64 and an exterior surface 66. Reticle 30 is secured inside housing 68 and comprises first wire 70 oriented perpendicularly to second wire 72. The interior housing surface 64 includes a circumscribing band of photoluminescent material 74 located adjacent reticle 30. Band 74 may be deposited or applied to surface 64 as described above or may comprise a separate band of frictional material placed inside housing 62. Moreover, band 74 may be located on either side of reticle 30 provided that the light emitted from the photoluminescent material is capable of sufficiently illuminating the reticle. Another alternative embodiment is provided in FIG. 8 which is identical to FIG. 7 with the exception of the band 74 which is contiguous in FIG. 7 but is broken or separated in the embodiment of FIG. 8. This band of material is shown as a series of spaced dash-shaped portions 74a, 74b, 74c, 74d forming a divided band circumscribing the interior of housing 62. Of course, the portions of photoluminescent material need not be in any particular shape provided that the shape and spacing of the photoluminescent portions provide enough illumination of the reticle for increased visibility in low-light conditions.

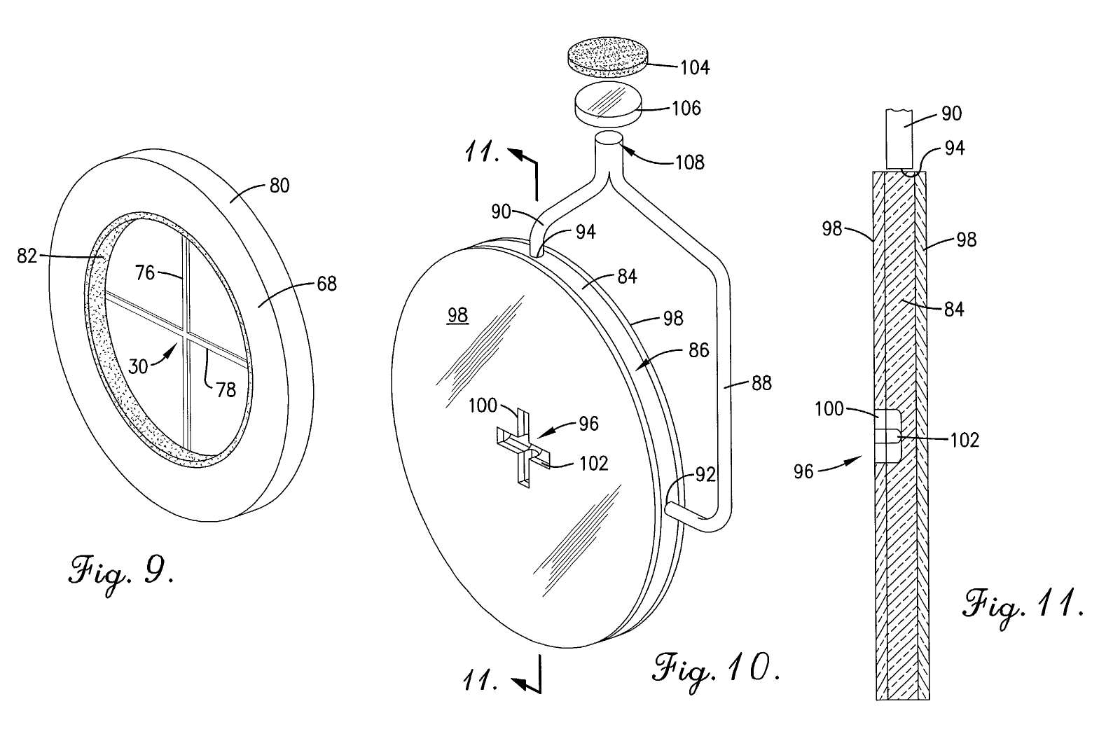

FIG. 9 illustrates a reticle 30 similar to those described for FIGS. 7 and 8. Reticle 30 has cross-hairs 76, 78 oriented perpendicularly to each other and secured within housing 68. Housing 68 is in the shape of a donut having exterior surface 80 and interior surface 82. The quantity of photoluminescent material is deposited on, or applied to interior surface 82 such that reticle 30 is illuminated by the light emitted from the photoluminescent material.

FIG. 10 illustrates yet another embodiment of the present invention comprising a disc 84 of optical material having a peripheral edge 86 circumscribing disc 84. A pair of light-transmitting pipes 88, 90 contact peripheral edge 86 and are located approximately 90° apart. Pipes 88, 90 each present a light-emitting end 92, 94 contacting peripheral edge 86 for emitting light into disc 84. Preferably, pipes 88, 90 are aimed at etched out portion 96 which is in the shape of a cross-hair reticle. Disc 84 further presents a coating 98 on each side thereof. This coating 98 may be an antireflective coating, a protective coating or a combination thereof. Etched out portion 96 is also etched out of coating 98 on one side thereof such that a groove extends through coating 98 and a portion of disc 84. Light transmitted through pipes 88, 90 is emitted from portion 96, thereby providing a lighted reticle shape which can be used in low-light conditions. Thus, in the field of view through a scope, when light is transmitted through pipes 88, 90, into disc 84 and emitted through portion 96, the reticle shape appears as a lighted cross-hair, thereby improving its use as a sighting marker in low-light conditions.

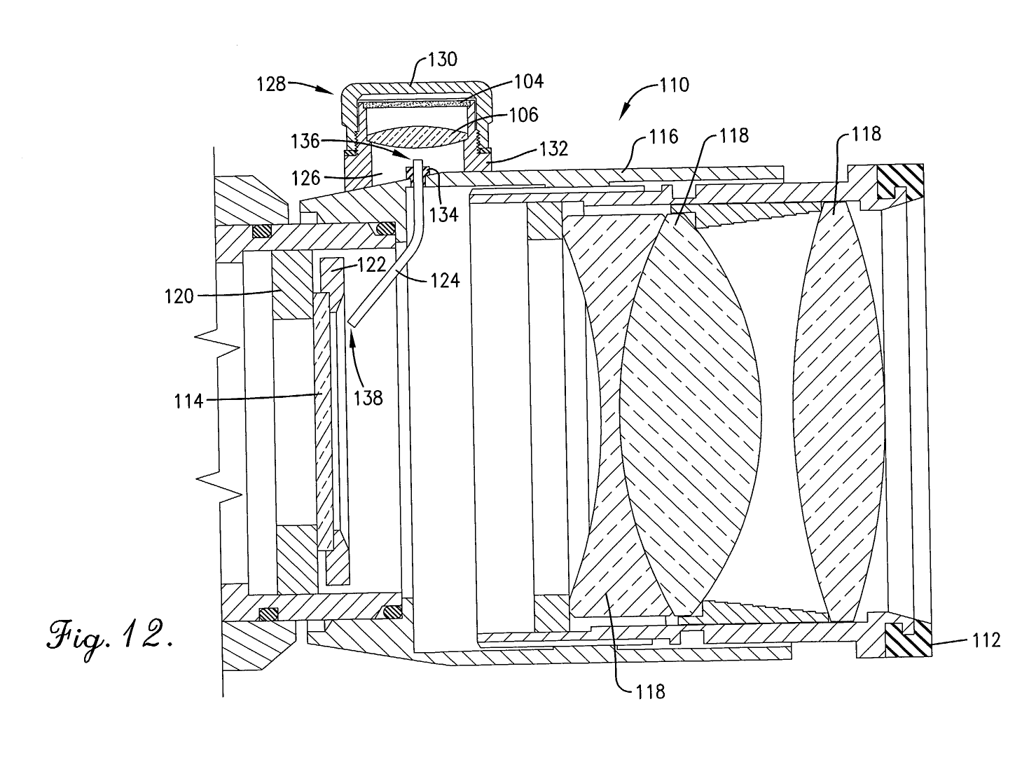

FIG. 11 illustrates a cross-sectional view through the center of FIG. 10. Etched out portion 96 is clearly shown to extend through one surface of coating 98 and into a portion of disc 84. Pipe 90 is aimed at one of the two cross-hair lines 100, 102 of portion 96. In use, disc 84 is positioned inside the housing of a scope such as the one illustrated in FIG. 12. As shown in FIGS. 10 and 11, light-transmitting pipes 88, 90 are optically connected to light emitted by a quantity of photoluminescent material 104. To assist in the transmission of light from material 104, a lens 106 is positioned to direct light from material into the light-receiving end of a light-transmitting pipe 108. This light is transmitted through pipes 88, 90 and into disc 84.

FIG. 12 illustrates a cross-sectional view of an eyepiece end of a scope. Eyepiece end 110 includes rubber eyecup 112 circumscribing one end of eyepiece 110, reticle 114 at the end opposite eyecup 112, connected by housing 116. Within housing 116 between reticle 114 and eyecup 112 are a plurality of lenses 118. Reticle 114 is positioned between reticle fastener frame 120 and reticle base 122. Light transmitting pipe 124 extends from an area adjacent reticle 114 into the interior 126 of turret 128. Turret 128 includes cap 130 threadably received on turret base 132 and preferably includes a quantity of photoluminescent material preferably located on the interior of cap 130. Turret interior 126 includes lens 106 which is positioned to receive emitted light from the photoluminescent material 124 on cap 130 when cap is placed onto turret 128. Pipe 124 is sealed by grommet 134 and positioned such that light emitted from photoluminescent material 104 is directed by lens 106 toward the light receiving end 136 of pipe 124 where it is transmitted through pipe 124 until it is emitted from light emitting end 138 and projected onto reticle 114 such that reticle 114 is illuminated. To use this embodiment, cap 130 is removed from base 132 to permit light to activate photoluminescent material 104. This removal can be done by unthreading or otherwise removing the cap 130 and exposing the material to a light source to activate the material. Once material 104 has been sufficiently activated, cap 104 is replaced onto base 132 and the light emitted by the photoluminescent material is transmitted toward the reticle through pipe 124. In some embodiments, the light is projected onto the reticle and in others, the light is projected into the reticle such as is shown in FIG. 10 or in FIG. 13 wherein the light transmitting pipe 124 (shown enlarged for detail) is affixed to the reticle such that the light transmitting end 138 projects light at the center point of the reticle 30e. Of course, pipe 124 can be located anywhere on the reticle 30e and will preferably run along one of the sighting markers such as 42a.

I claim:

1. In a reticle adapted for use in a scope, the improvement which comprises a quantity of photoluminescent material deposited on at least a portion of said reticle.

2. The reticle of claim 1, said photoluminescent material substantially covering said reticle.

3. The reticle of claim 1, said photoluminescent material having an average particle size less than about 30 μm.

4. The reticle of claim 3, said average particle size being between about 2 μm and 20 μm.

5. The reticle of claim 4, said average particle size being between about 5 μm and 10 μm.

6. The reticle of claim 1, said photoluminescent material providing an enhanced sighting marker portion of said reticle.

7. The reticle of claim 1, said reticle comprising a first line.

8. The reticle of claim 7, said reticle further comprising a second line oriented perpendicular to said first line.

9. The reticle of claim 1, said reticle comprising at least one dot.

10. The reticle of claim 1, said reticle including a ring.

11. The reticle of claim 7, said first line having a width of less than about 100 μm.

12. The reticle of claim 11, said first line having a width between about 15 μm and 50 μm.

13. The reticle of claim 12, said first line having a width between about 20 μm and 35 μm.

14. The reticle of claim 1, said reticle comprising material being selected from the group consisting of paint, tape, and combinations thereof.

15. A reticle comprising a plate of optical material having at least one sighting marker thereon, said sighting marker comprising a quantity of photoluminescent material.

16. The reticle of claim 15, said photoluminescent material having an average particle size less than about 30 μm.

17. The reticle of claim 16, said average particle size being between about 2 μm and 20 μm.

18. The reticle of claim 17, said average particle size being between about 5 μm and 10 μm.

19. The reticle of claim 15, said photoluminescent material being deposited on said sighting marker.

20. The reticle of claim 15, said sighting marker comprising a first line.

21. The reticle of claim 20, said sighting marker further comprising a second line oriented perpendicularly to said first line.

22. The reticle of claim 15, said sighting marker comprising at least one dot.

23. The reticle of claim 15, said sighting marker including a ring.

24. The reticle of claim 20, said first line having a width of less than about 100 μm.

25. The reticle of claim 24, said first line having a width between about 15 μm and 50 μm.

26. The reticle of claim 25, said first line having a width between about 20 μm and 35 μm.

27. The reticle of claim 15, said sighting marker comprising a material selected from the group consisting of paint, tape, and combinations thereof.

28. A scope comprising:
a housing, said housing including an interior surface, a first end having an eyepiece, and an opposed second end having an objective lens;
a reticle positioned between said first end and said second end; and
a quantity of photoluminescent material deposited on said interior surface of said housing.

29. The scope of claim 28, said reticle comprising a plate of optical material having a sighting marker thereon.

30. The scope of claim 28, said photoluminescent material operable for casting light on said reticle.

31. The scope of claim 29, said photoluminescent material operable for casting light on said sighting marker.

32. The scope of claim 28, said photoluminescent material being located adjacent said reticle.

33. The scope of claim 28, said photoluminescent material being deposited in the shape of a ring around the interior of said housing.

34. The scope of claim 33, said ring circumscribing said interior of said housing.

35. The scope of claim 33, said ring having a width less than about 100 μm.

36. The scope of claim 28, said photoluminescent material having an average particle size less than about 30 μm.

37. The scope of claim 36, said average particle size being between about 2 μm and 20 μm.

38. The scope of claim 37, said average particle size being between about 5 μm and 10 μm.

39. The scope of claim 29, further comprising a quantity of photoluminescent material deposited on said sighting marker.

40. The scope of claim 39, said sighting marker comprising a first line.

41. The scope of claim 40, said sighting marker further comprising a second line oriented perpendicular to said first line.

42. The scope of claim 29, said sighting marker comprising at least one dot.

43. The scope of claim 29, said sighting marker including a ring.

44. The scope of claim 40, said first line having a width of less than about 100 μm.

45. The scope of claim 40, said first line having a width between about 15 μm and 50 μm.

46. The scope of claim 45, said first line having a width between about 20 μm and 35 μm.

47. The scope of claim 28, said scope selected from the group consisting of riflescopes, telescopes, spotting scopes, and binoculars.

48. The scope of claim 29, said sighting marker comprising material selected from the group consisting of paint, tape, and combinations thereof.

49. A scope comprising:
a housing, said housing including an interior surface, an opposed exterior surface, a first end and an opposed second end, said first end having an eyepiece and said second end having an objective lens, said housing further including a reticle positioned intermediate said first end and said second end;
a quantity of photoluminescent material mounted on said housing remote from said reticle; and
a light-transmitting pipe between said photoluminescent material and said reticle, said pipe operable for transmitting light from said photoluminescent material to said reticle.

50. The scope of claim 49, said reticle comprising a plate of optical material having a sighting marker thereon.

51. The scope of claim 49, said pipe comprising fiber optic cable.

52. The scope of claim 49, said pipe operable for casting light on said reticle.

53. The scope of claim 51, said pipe operable for casting light on said sighting marker.

54. The scope of claim 49, said photoluminescent material having an average particle size less than about 100 μm.

55. The scope of claim 54, said photoluminescent material having an average particle size between about 2 μm and 80 μm.

56. The scope of claim 49, further comprising a quantity of photoluminescent material deposited on said reticle.

57. The scope of claim 49, said reticle comprising a first line.

58. The scope of claim 57, said reticle further comprising a second line oriented perpendicular to said first line.

59. The scope of claim 49, said reticle comprising at least one dot.

60. The scope of claim 49, said reticle including a ring.

61. The scope of claim 57, said first line having a width of less than about 100 μm.

62. The scope of claim 61, said first line having a width between about 15 μm and 50 μm.

63. The scope of claim 62, said first line having a width between about 20 μm and 35 μm.

64. The scope of claim 49, said scope selected from the group consisting of riflescopes, telescopes, spotting scopes, and binoculars.

65. The scope of claim 49, said light transmitting pipe having a light-receiving end and an opposed light-emitting end, said reticle comprising an enhanced sighting marker comprising the light-emitting end positioned to project light toward said eyepiece.

66. A reticle comprising:
a plate of optical material having a circumscribing edge;
at least one light-transmitting pipe attached to said edge, said light-transmitting pipe being optically connected to a quantity of photoluminescent material and presenting a light-receiving end adjacent said photoluminescent material and a light-emitting end adjacent said edge; and
a pattern on said plate, said pattern being formed by the removal of optical material in the shape of said pattern whereby light emitted from said light-emitting end is transmitted through said plate and is emitted from said plate in said pattern.

67. The reticle of claim 66, said reticle comprising two light-transmitting pipes spaced apart approximately 90°.

68. The reticle of claim 66, said pattern comprising two intersecting lines.

69. The reticle of claim 66, said reticle further comprising a coating on said plate, said coating being selected from the group consisting of anti-reflective coatings, protective coatings, and combinations thereof.

70. The reticle of claim 69, said coating being removed over said pattern.

71. The reticle of claim 66, said reticle being contained in a housing and said photoluminescent material being located on said housing.

72. A method of increasing the visibility of a reticle in low-light conditions comprising the step of:
illuminating said reticle using the light emitted from a quantity of photoluminescent material.
